(19) United States
(12) Patent Application Publication
(10) Pub. No.: US 2011/0090492 A1
(43) Pub. Date: Apr. 21, 2011

(54) Method of evaluating defects in a material transparent to electromagnetic radiation, especially for optical applications, apparatus for performing said method, and materials selected thereby

(76) Inventors: Christian Lemke, Jena (DE); Manuela Lohse, Jena (DE); Lars Ortmann, Jena (DE); Stephan Strohm, Jena (DE); Albrecht Hertzsch, Jena (DE); Karl Hehl, Jena (DE)

(21) Appl. No.: 12/888,775

(22) Filed: Sep. 23, 2010

(30) Foreign Application Priority Data
Sep. 25, 2009 (DE) 10 2009 043 001.6

(51) Int. Cl. G01N 21/958; G01N 21/00; C03B 20/00

(52) U.S. Cl. 356/239.2; 65/29.11; 65/29.12; 359/831

(57) ABSTRACT

The method of evaluating an optical defect in a transparent material includes irradiating the material with light to produce scattered light from the defect, rotating the material about a rotation axis passing through the defect, measuring scattered light intensity at a scattering angle (θₛ) to the rotation axis by means of a detector, determining the dependence of the measured scattered light intensity on rotation angle (φₛ) around the rotation axis and characterizing size and/or shape of the defect from that dependence. The apparatus for performing the method has a light source, a rotatable holder for the transparent material, a light sensitive receiving device and an imaging optical system for imaging scattered light from the material within a certain angular range on a detector surface of the receiving device.

### CROSS-REFERENCE

The subject matter described and claimed herein below is also described in German Patent Application No. 10 2009 043 001.6, filed on Sep. 25, 2009 in Germany. This German Patent Application provides the basis for a claim of priority of invention for the invention described and claimed herein below under 35 U.S.C. 119 (a)-(d).

### BACKGROUND OF THE INVENTION

1. The Field of the Invention

The present invention relates to a method of identifying and/or evaluating defects in materials, especially for optical applications, by detection of radiation scattered by the defects, particularly by means of a CCD photodetector or other position resolving photodetector. The invention also relates to an apparatus for performing the method, which comprises a source of electromagnetic radiation, a holder for the materials that is pivotable or rotatable as needed and a detector for detection of scattered radiation that is also pivotable or rotatable as needed. The invention also relates to the use of the materials evaluated by the method.

2. The Description of the Related Art

In many optical applications, especially those involving light with high initial power or high pulse energy, such as laser light, optical elements, such as lenses, prisms, masks, mirrors or filters, must be of an especially high quality and meet demanding specifications. Besides good transmission properties very good uniformity, very few bubbles and very few inclusions are required according to the application.

Currently the determination of the properties of optically active defects, such as their size, shape and position as well as their type, also of bubbles and inclusions in the interior of optically transparent materials, occurs by judgment based on visual observations. For this purpose an approximately parallel light beam is passed through a sample to be tested and the size and position of material defects detectable in the light beam is estimated. The judgment can be confirmed with a microscope. However this sort of testing is time consuming, requires great concentration on the part of the individual performing the test, and must occur in a darkroom. Furthermore this process only results in an estimate. No quantitative measurements of the size and position of the material defects results. In addition, this testing process is based on the judgment of the individual performing the process and the shape of the defects generally cannot be ascertained. Furthermore the testing process is limited to material defects that are larger than 10 to 20 μm. Thus materials that must fulfill the highest quality specifications, especially regarding material defects with a size of about 1 micron or less, cannot be evaluated with these testing methods.

The use of scattered light to detect particles is known in itself. Thus DE 199 32 870 A1 describes an apparatus for optical particle and particle motion analysis, with which an optically transparent measurement volume containing a liquid medium, a gaseous medium, or a vacuum is illuminated and an image of the measurement volume is recorded by means of a camera on a microscope. The apparatus makes it possible to detect the motion and flow properties of the particles in the medium. However it is not possible to evaluate the particles and no further information can be obtained with this method. I.e. the three-dimensional position, type, size and shape of the particles cannot be determined with this method.

Furthermore particle shape cannot be determined and the measurement volume and/or region are very limited in the known Doppler phase difference method described by Damaschke, et al, Appl Optics 37: pp. 1752-1761 (1998).

GB 2,379,977 A describes another method for detection of particles that is used in a smoke detector. In this method the intensity of the light scattered by the particles is determined by adding up the scattered light from a plurality of particles in a measurement volume with the help of a camera. However this sort of apparatus only detects spherical particles and does not permit any determination of the type and shape of the particles. Also an exact determination of the position of the particles is not possible.

In addition a method of detecting local defects (bubbles and/or inclusions) is described in the paper “System for Detection of Small Inclusions in Large Optics” (Wolfe, Runkel), Proc. of the SPIE, 7132 (2008). In this method a laser beam scans a volume to be tested. As soon as a local defect is encountered by the laser beam, the scattered light is evaluated with a camera. Subsequently the size of the defect is determined by means of an optical system. The difficulties of this method relate to the detection of defects that are less than 5 μm in size, but not to the analysis of the detected defects.

### SUMMARY OF THE INVENTION

It is an object of the present invention to provide a method and an apparatus, with which the optical quality of a sample of an optically transparent material can be rapidly quantitatively and qualitatively characterized in a simple and cost effective manner.

It is a further object of the present invention to provide a method and an apparatus, with which the size, the position and the shape, e.g. rod-, circular- or oval-shaped, of scattering centers in the micron size range, especially down to a size of at least about 0.5 μm can be rapidly quantitatively and qualitatively measured.

An additional object of the invention is to provide a method comprising an unambiguous, comprehensive and recordable analysis or evaluation of the scattering centers, which requires so little time that it is possible to include it in a manufacturing production line.

These objects are attained by the method and apparatus set forth in the appended claims.

According to the invention it was found that the intensity of the scattered radiation from a defect in an optically transparent material irradiated with a beam of electromagnetic radiation, which is detected within an angular range, varies periodically, whereby an irregular pattern of scattered radiation of periodic variation of light scattering intensities arises. The size and shape of the respective defects within that angular range can be determined by correlation of the size and frequency of the scattered light intensity changes (modulation of the intensities and/or frequency of the changes).

From a comparison of measured variations of the scattered light intensity with the amplitude and frequency of intensity variations calculated with the help of a diffraction model, it is possible to determine the size, shape and type of the respective optical defect associated with the measured variations of the scattered light intensity. In this way it was found that these periodic variation patterns could be characterized with classical methods for determination of the waviness or periodic variations of surfaces, e.g. as they are applied also for sealing surfaces, guide surfaces and roller surfaces.

According to the invention thus the changes of the intensities of the scattered light caused by the scattering center or the defect are measured by a detector either during an azimuthal rotation of the material about a rotation axis extending in the propagation direction of the electromagnetic radiation beam or by azimuthal radial pivoting of the detector about that rotation axis. In this way the scattered light is evaluated at a constant scattering angle relative to the rotation axis. The scattering intensity is measured for a solid scattering angle as a function of azimuthal rotational position or pivot angle φ during an azimuthal rotation of the detector or the sample through a predetermined arc dφ. The angular resolution of the scattered light modulation is given by the angular step width and the numerical aperture of the detector. An angular step width of 0.61° to 0.5° and a dφ of 0.1°±0.05° have be used in practice.

The rotation or pivot axis corresponds to the beam of electromagnetic waves, e.g. a laser beam. Only a minimal parallel displacement between the mechanical rotation axis and the optical illumination axis can be tolerated when the rotation axis and the beam pass through the defect in the material.

In one useful embodiment the detector receives the scattered light from the defect by image formation in a definite scattering angle with a mirror and a lens. Advantageously the received scattered light is imaged by an objective on the detector surface so that a photosensitive device such as a CCD camera, a photodiode or an SEV detector receives the scattered light exclusively from the defect. The measured scattered light intensity is a sum of the scattered light intensities received over the detector surface. The numerical aperture of the objective gives the received solid angle of the scattered light and should be in the range of the azimuthal angular resolution.

The scattered light can be produced by irradiation with any type of electromagnetic waves. Such waves include light, especially visible light, IR light, UV light and also extreme UV light. Preferably laser light is used. The irradiating or exciting light is appropriately a parallel light beam. The irradiating electromagnetic waves appropriately form a beam of coherent waves, especially circularly, radially or linearly polarized waves. Preferred lasers for producing the laser beams are powerful HeNe lasers with a wavelength of 633 nm and an output power >20 mW and solid-state lasers with a wavelength of 532 nm with an output power of >50 mW.

It is possible to scan the volume of the optical material or the test sample with a grid-like pattern by using a narrow laser beam. In this way the position, size, shape and type of all defects can be measured and mapped in the entire space or volume of the material to be measured.

In a further preferred embodiment according to the invention azimuthal-angle-resolved scattered light intensities produced by the defect in at least one or if necessary at several scattering angles are measured. For that purpose, as previously described, the material or the test sample is rotated about a rotation axis extending through the defect over a certain azimuthal angular range and the variations of the intensity of the scattered light are measured at least one scattering angle.

Understandably it is also possible to pivot or rotate the detector spaced radially from the rotation axis over an azimuthal angle range around the rotation axis. According to the invention it was surprisingly found that the type of the defect may be identified from the difference of the average scattering intensities for two different scattering angles. Thus a small intensity difference of respective intensities measured at correspondingly different scattering angles indicates an inclusion of a particle different from the optical material, such as a gas bubble or a foreign body. If the defect is made from the same material or a material with an index of refraction that is comparable to that of the material of the tested sample for the light employed, surprisingly it was found that the average intensities of the scattered light at different detection angles were greatly different. In this way with the method according to the invention it is possible for the first time to determine not only the position but also the shape and type of the respective defects. This index of refraction-dependent intensity drop for greater scattering angle can also be described with the known Mie model. A sufficient measureable difference of the average intensities is in a range of 25 to 250, especially of 20 to 45, e.g. for the preferred scattering angles of Θ₁=25°±2° and Θ₂=30°±2° and/or Θ₂=30°±2° and Θ₃=40°±2°.

In a preferred embodiment of the invention the detector and/or the detector unit includes an imaging optical system, which collects the scattered light over a certain azimuthal-angle range for a definite scattering angle and the azimuthal-angularly resolved scattering intensities are measured.

The imaging optical system preferably includes an annular mirror, which guides divergent scattered rays originating from the defect into a bundle of parallel rays, and/or a number of lenses in an annular arrangement, which guide the scattered radiation to a detector unit. In a further embodiment preferred according to the invention the plurality of lenses in an annular arrangement is replaced by a single annular lens. One such annular lens has a circular or annular convex lens surface and a lens cross-section that is constant over its entire circular periphery. The scattered light collected by the annular mirror and/or annular lens is then conducted further to a light-sensitive device, such as a CCD matrix or a photodiode array. There the entire azimuthal scattered light distribution is imaged as a ring with angular resolution for a definite scattering angle. When an image-side telecentric image should be guaranteed, the plane of the imaging optics is shifted toward the test object by a change of the spacing of the annular lens and annular mirror. In this way it is possible to image and evaluate different defects at different depths in the test sample. In a further preferred embodiment the spacing of the annular lens and annular mirror from the test sample is measured by a signal transmitter and input directly into a computer-controlled recording device or memory unit. In this way the respective scattering properties can be stored, correlated and mapped to every arbitrary point in the test sample or optical material.

The apparatus according to the invention that is used to perform the process appropriately includes a holder or support for the optical material to be tested, i.e. the test sample. This support can be pivoted or rotated over 360° around a rotation axis. Furthermore the holder has a device, with which the test sample is displaceable relative to the rotation axis, and indeed so that the optic axis can pass through every part of the test sample. In this way it is possible to irradiate and evaluate the entire volume of the test sample or the material to be tested by scanning over the entire volume. For this purpose the apparatus contains a signal transmitter, which stores the actual position of the test sample relative to the optic axis of the detector unit in a computer-controlled recording device or memory unit. Thus the azimuthal-angularly resolved scattered light intensities may be measured at each point throughout the volume of the test sample by relative displacement of the detector unit and the test sample and a three-dimensional mapping of the type, size and shape of the optical defects may be obtained.

In contrast to a point-source-type measurement of the scattered light the measurement of the scattered light intensities over a scattering angle range permits the detection of very small and/or large direction-dependent scattering centers, for example material defects in the micron size range, especially for example with a size of 0.5 μm. The theoretical minimum detectable defect size according to the Mie model is determined from the following known formula:

Xₘ=πdₚ/λ with Xₘ>0.2,

wherein dₚ is the particle diameter, λ is the wavelength and Xₘ is the Mie parameter.

Optically transparent materials are for example fused silica (quartz glass), calcium fluoride (CaF₂), magnesium fluoride (MgF₂), boron silicate crown glass (BK 7), ZERODUR® and quartz crystals.

In a most preferred embodiment the rotation axis passes through the material defect causing the scattering. Thus the scattered light caused by the material fault or defect can be collected or received as a function of rotation angle with angular resolution, i.e. within a predetermined angular range, by rotation of the imaging optical system or the test sample about the rotation axis. The type, the size and the shape of a material defect in the test sample can thus be determined from the assignment or correlation of the respective scattered light intensities with rotation angle.

Preferably the apparatus according to the invention includes a computer. The computer allows the recording and processing of the measured scattered light intensity and the position of the scattering defect ascertained by the signal transmitter. Because of that the exact position of the defect in a coordinate system as well as the scattered light distribution can be recorded and reconstructed.

Preferably the imaging optical system includes a limiting means, so that as little as possible scattered light from the inlet surface or the outlet surface in or on the test sample, which is generated by the light beam, is imaged or reaches the detection device. It is especially preferred that the limiting means is an aperture and/or a suitable beam forming means arranged in the path of the scattered light. Similarly it is preferred that the inlet surface and the outlet surface of the test sample do not produce light scattered light from the light beam. It is especially preferable that that is accomplished by polishing the surfaces and/or wetting them with an immersion solution, so that the measurements are influenced as little as possible by the scattering arising at those surfaces. Furthermore the limiting preferably occurs in the computer with a suitable algorithm embodied as a software program.

In a further embodiment according to the invention the periodic variations of the scattering intensity over the rotation or azimuthal angle is characterized by the procedures and regulations for judging the surface structure or condition and its periodic variation described by VDA 2007 (Automobile Industry Association VDA, Motor Vehicle Characteristics Reference Data, registered association (DFK), Ulrichstrasse 14, D-74321 Bietigheim-Bissengen, Germany). Parameters for the statistical analysis of the oscillations or variations of the azimuthal scattering distribution, for example the average height WDc, the total height WDt, the average horizontal wave or variation characteristic width WDSm, as well as the total intensity and anisotropy, are described. The size, the index of refraction, the shape and the orientation of the material defect can be determined by approximation of the measurement results with theoretically calculated curves by means of e.g. a databank in a computer containing the scattered light distribution and with the help of a vectorial Kirchhof's diffraction model for artificial defects. The comparison of the measured results preferably occurs with the aid of a sample library, which contains a number of measurement results for test samples with material defects of a different type, size and location, which facilitates the comparison.

A quantitative determination of the optical quality of a test sample of a transparent material, which can be used in transmission and also reflection applications, is possible with the method and apparatus for measuring scattered light. A light beam incident on a test body produces scattered light and/or an azimuthal-angle-resolved scattered light intensity, in at least one, preferably, two predetermined scattering angles or scattering angular ranges. The scattered light intensity for a respective azimuthal angle is determined by summing up or integrating the scattered light intensities measured within a scattering angle range.

The measured scattered light intensity distribution or its variations is a significant measurable variable that depends on the azimuthal and/or rotation angle. The shape, size, type and the position of the material defect causing the light scattering may be revealed from the position and magnitude of the peaks of the scattered light intensity variations (distribution), while the position of the material defect can be given in coordinates with a signal transmitter. Material defects with a size of about 0.5 μm are detectable with the scattered light measurement apparatus according to the invention and the method according to the invention for measurement of scattered light intensities. The computer permits the evaluation of the measurement results and reproducible output and recording of the measurements. A total image of the test sample can be prepared from the three-dimensional detection (mapping) of the scattered light intensities. On the other hand images of individual material defects can also be prepared. The coordinates of the material fault or defect are detectable with an accuracy of at least ±0.5 mm. The size of the material defect can be determined with an accuracy of at least ±0.5 mm. The material defects are tabulated and are visually illustrated according to their type. Finally both test samples with rough surfaces and also with polished surfaces can be tested or examined.

The scattered light measurement apparatus and the method of measuring scattered light intensities are above all useful, when material defects should be detected. It is especially suitable for fusion optics, most especially suitable for large panels of fused silica for laser fusion. Products with dimensions up to 500×500×50 mm³ (test direction 50 mm) may be measured without further effort. The apparatus and method of the invention are useable and permit the testing of such products in less than 2 hours. Principally test sample thicknesses of up to 250 mm may be measured in the apparatus according to the invention.

The invention also concerns an imaging optical system, with which point-like small objects, such as volume units or optical defects, inclusions, etc can be detected on a photosensitive panel, such as in a CCD-device. The imaging optical system includes an annular arrangement. In a simple embodiment it includes a plurality of lenses, which are arranged around the periphery of a circle, wherein the center of the circle and the center of the collimator mirror form a symmetry axis of the imaging optical system. In an especially preferred embodiment the annularly arranged lenses are combined in a single circular annular lens, i.e. the annular lens comprises an annular bead or convex section, whose curvature corresponds to the convexity of the lens. This sort of annular lens has the same cross-sectional shape at each point around its circumference. The parallel rays incident on the annular lens, which were reflected from a mirror if necessary, are conducted from the annular lens to a further mirror surface arranged behind the lens to a CCD-device or any light sensitive apparatus, which qualitatively or quantitatively measures the intensity of the light rays falling on it.

A preferred embodiment of the apparatus according to the invention comprises a collimator, which guides the divergent light rays issuing from the point-like object, so that they are subsequently parallel to each other. It is appropriately a mirror. Preferably it has an annular shape. However principally it also can comprise only two or more opposed smaller mirrors, which similarly direct the light rays so that they are parallel to each other, i.e. they also have collimator properties. Principally any collimator can be used for this purpose. The parallel light rays from the collimator are guided to the lens.

In a further preferred embodiment of the invention two annular lens arrangements are arranged concentric to the scattered light beam in the scattered light detection optical system. In this way it is possible to measure the scattered light at two different scattering angles at the same time or at different times. However it is also possible to measure the scattered light intensities at the different scattering angles by means of two different lenses with different diameters placed one in front of the other.

It is possible to scan a large test sample in a time interval of about two hours with the procedure according to the invention. However in this case it is preferable to subject the test sample to a gross scan and to identify the individual defects and to locate their spatial position. This can occur usually be means of two different laser beams.

### BRIEF DESCRIPTION OF THE DRAWING

The objects, features and advantages of the invention will now be illustrated in more detail with the aid of the following description of the preferred embodiments, with reference to the accompanying figures in which:

FIG. 1 is a schematic partially perspective view of an arrangement for measurement of scattering from defects in a transparent material according to the invention;

FIG. 2 is a schematic cross-sectional view through an imaging optical system with an annular lens and an annular collimator of the apparatus according to the invention;

FIG. 3 is a perspective view illustrating the method of measurement of scattering intensities from a test sample according to the invention;

FIG. 4 is an image of light scattered from a light beam passing through a test sample with a material defect;

FIG. 5a is graphical illustration of the angular variations of the scattered light intensity over an angular range of 360° for different size defects in an optical glass;

FIG. 5b is graphical illustration of the angular variations of the scattered light intensity over an angular range of 350° for scattering from a fire-resistant material in quartz glass at scattering angles of 30° and 40°; and

FIG. 5c is graphical illustration of the angular variation of the scattered light intensity over an angular range of 350° for scattering from an artificially created defect (polishing dust) in quartz glass at scattering angles of 30° and 40°.

### DESCRIPTION OF THE PREFERRED EMBODIMENTS

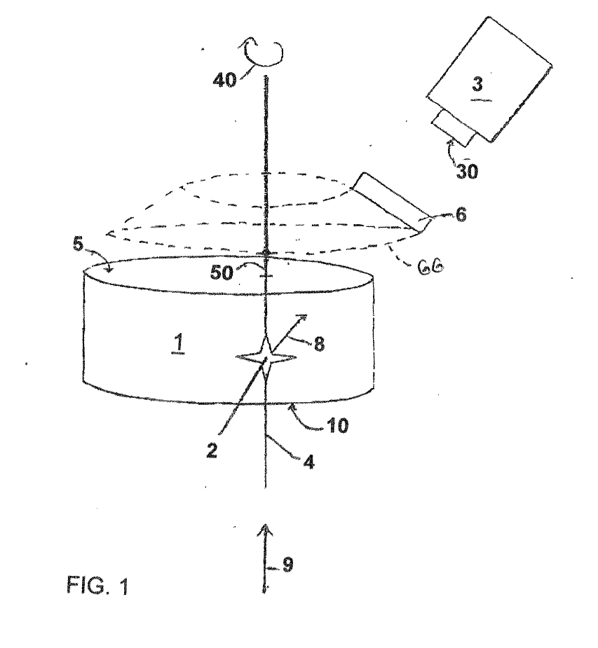

FIG. 1 is a diagrammatic view of the main parts of a scattered light measuring apparatus. The scattered light measuring apparatus comprises an imaging optical system or detection optics 6, with which the scattered light, indicated here by an arrow 8, which is scattered from a material defect or optical defect in a test sample 1, is imaged or focused on a detector surface 30 of a receiving or detection device 3, especially a CCD camera, The test sample 1 or the detection optics 6 is rotated about a rotation axis 4 in a rotation direction 40, so that the test sample 1 and the imaging optical system 6 can be moved to different positions, especially rotational positions, relative to each other. If necessary the receiving device 3 can be rotated together with the imaging optics 6. The rotational position of the imaging optics 6 may be changed by rotation of the imaging optical system 6 about the rotation axis 4, which is indicated by the dashed line 66 in FIG. 1. A light beam 9, which falls on an inlet surface 10 of the test sample 1, is shown as an arrow. A surface normal 50 on the outlet surface 5 for the scattered light 8 on the test sample 1 is also shown with an arrow. A laser light beam is used as the light beam 9.

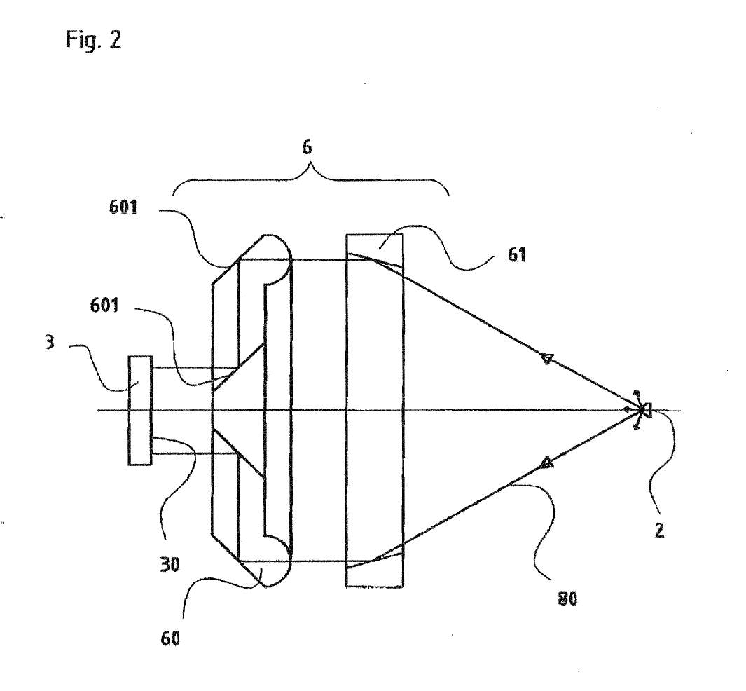

FIG. 2 shows a preferred imaging optical system or detection optics 6 of the apparatus according to the invention. Scattered light from a material defect 2, of which only two rays 80 are illustrated, falls on an annular mirror 61 of the imaging optical system 6. The annular mirror 61 receives the scattered light and reflects the scattered light rays 80 into an annular lens 60 of the imaging optical system 6. The annular lens 60 has a mirror system 601, which images the scattered light rays 80 on the detector surface 30 of the receiving device 3. Those rays, which fall on the inner circular surfaces of the annular lens, are generally not detected by the detection optics.

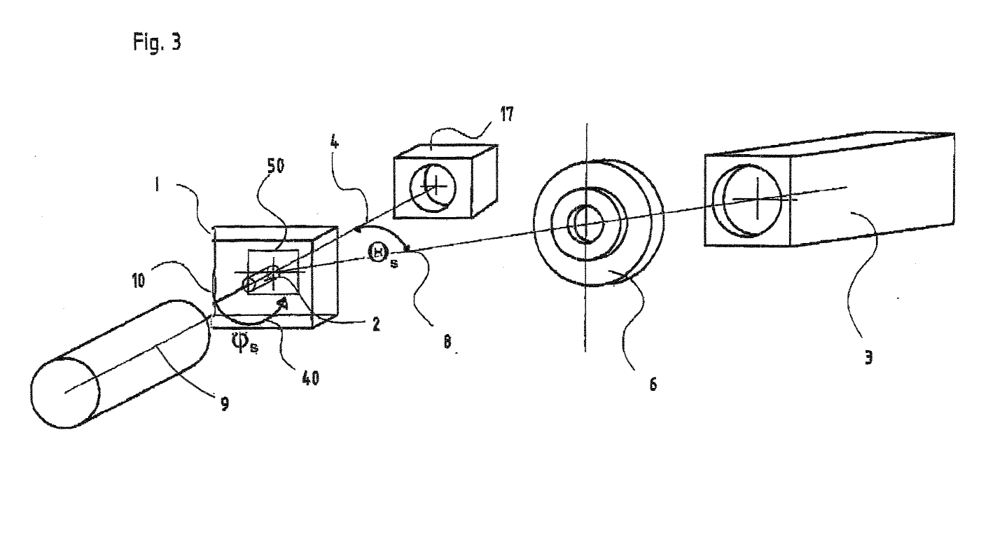

FIG. 3 is a schematic view of the apparatus according to the invention including a test sample 1. The light beam 9 falls on the inlet surface 10 of the test sample 1, passes through it and out from its outlet surface 5. The light beam 9 is scattered at a material defect 2 in the sample. The scattered light indicated by a ray 8 in the center of the scattered light beam emerges from the test sample 1 at an angle θₛ to the surface normal (see FIG. 1) of the outlet surface 5. A non-scattered portion of the light beam 9 is captured in a light- or beam-trap 17. The scattered light 8 is imaged on the detector surface 30 of a receiving device 3 by means of detection optics 6, which if necessary includes a diaphragm 14. In the case of this embodiment the detection optics includes a mirror 16, an objective 15 and diaphragm 14. Scattered light within a certain scattering angle, which is determined by the scattering angle θₛ of the scattered light to the surface normal 50 of the outlet surface 5 and the numerical aperture of the objective 6 (see FIGS. 1, 3), can be collected with the objective 6. Scattered light is produced from the material defect 2 and is detected by the imaging optics 6 and the receiving unit 3 at different scattering and azimuthal angles by rotation of the test sample 1 about the rotation axis 4. Alternatively scattered light for a plurality of azimuthal angles can be received in a predetermined scattering angle range determined by the objective 6 at different scattering angles by rotation of the imaging optical system 6 about a rotation axis 4 (corresponding the rotation axis of a test sample) passing through the entrance and outlet positions of the light beam.

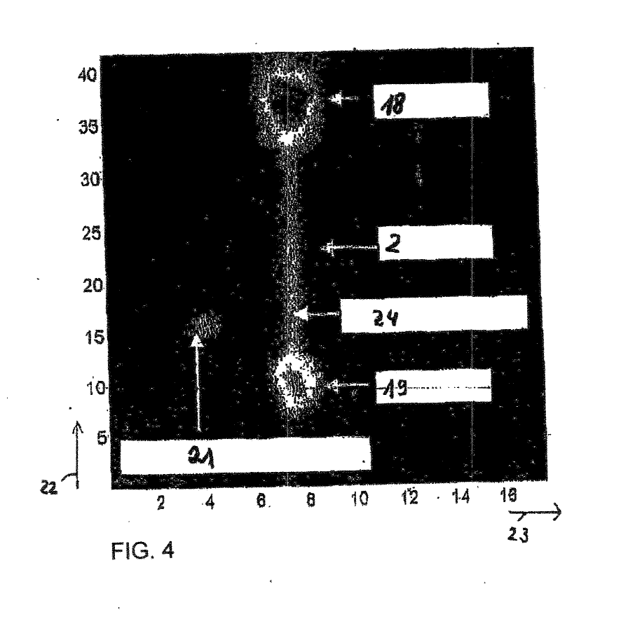

FIG. 4 is an image of scattered light from a light beam passing through the test sample. The scattered light image comprises a scattered light image 24 of the beam itself, a scattered light image 18 of the inlet surface of the test sample, a scattered light image 19 of the outlet surface of the test sample and a scattered light image 21 of an artifact at the surface of the test sample. The depth position of the path of the rays is given on the x-axis 22 of the image. The scanning distance of the points in the test sample is given on the y-axis 23.

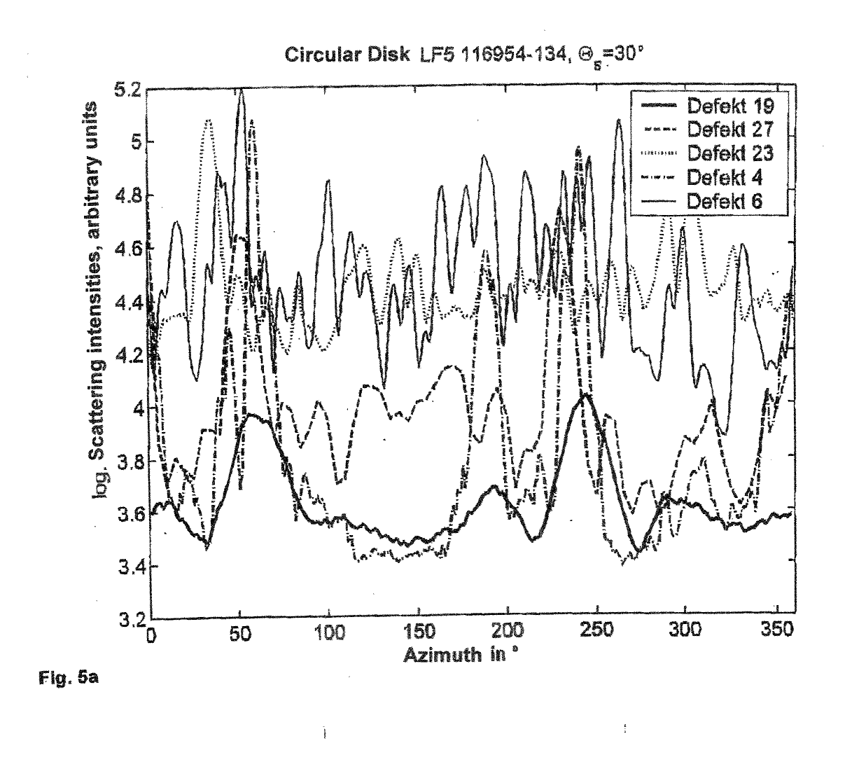

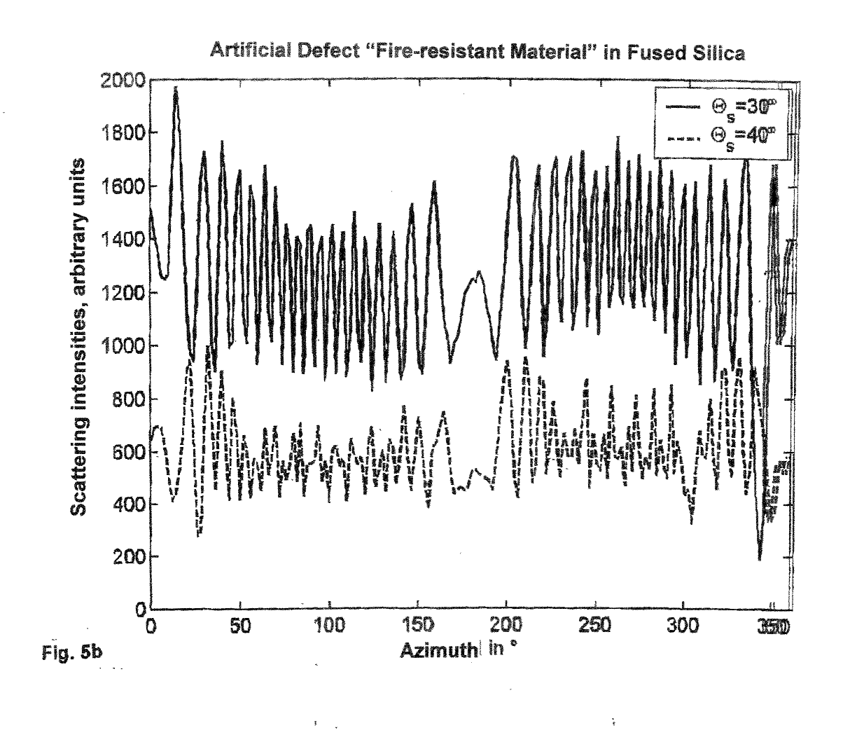

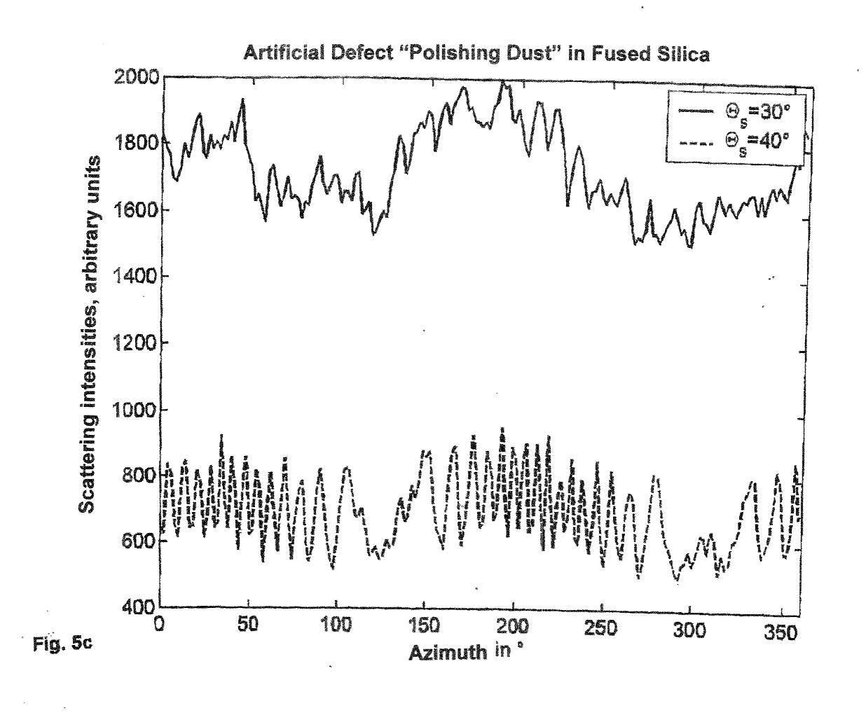

FIG. 5a illustrates the angular variation in scattering intensities from five defects in glass over a complete rotation of 360°. All the defects were evaluated with at same scattering angle (θₛ=30°) to the rotation axis.

Different defects produce different types of frequency variations or periodic variations of the scattered light intensities with azimuthal angle and the average scattering intensity varies for different types of defects.

FIG. 5b shows the angular variation of scattered light intensities produced by an artificial defect comprising fire-resistant material (fire-resistant clay) in quartz glass. The scattered light intensities were measured at two different scattering angles, namely once at θₛ=30° and once at θₛ=40°, Here the respective scattered light intensities from this defect for both scattering angles have a comparatively small difference from each other, namely only about 500 to 600 intensity units.

FIG. 5c shows the angular variation of scattered light intensities produced by polishing dust in quartz glass, i.e. from an inclusion of that material at different scattering angles. The scattered light intensities were measured at two different scattering angles, namely once at θₛ=30° and once at θₛ=40°. As can be seen from this figure, defects of the same material or the same material or materials of comparable refractive index, have greatly different average light scattering variations depending on the scattering angle.

### PARTS LIST

1 test sample, material sample
10 inlet surface for the light beam in the test sample
2 material defect, inclusions, bubble, cord
3 receiving device, CCD camera
30 detector surface of the receiving device
4 rotation axis of the sample or the detection optics
40 rotation direction
5 outlet surface of the test sample
50 surface normal to the outlet surface
6 detection optics or imaging optical system
60 annular lens
601 mirror system
61 mirror, annular mirror
66 path of the imaging optical system during rotation about the rotation axis
8 scattered light
80 scattered light path
θₛ scattering angle, i.e. the angle between the rotation axis and the propagation direction of the detected scattered light or the axis of the detection optics
φₛ azimuthal angle of the scattered light, i.e. the angle of the axis of the detection optics around the rotation axis
9 light beam, laser beam
14 diaphragm
16 mirror
17 light trap
18 image of the inlet surface of the test sample
19 image of the outlet surface of the test sample
21 image of an artifact of the test sample
22 depth, mm
23 length, mm
24 image of the light beam

While the invention has been illustrated and described as embodied in a method of evaluating defects in a material transparent to electromagnetic radiation, especially for optical applications, apparatus for performing said method, and materials selected thereby, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

1. A method of evaluating optical defects in a transparent material, said method comprising the steps of:
a) irradiating the transparent material with light from a light source so as to produce scattered light from an optical defect;
b) rotating the transparent material about a rotation axis passing through said optical defect through at least one rotation angle (φₛ);
c) measuring scattered light intensities at a scattering angle (θₛ₁) during the rotating with respect to the rotation axis by means of a detector;
d) determining a dependence of the scattered light intensities measured in step c on said rotation angle (φₛ) about the rotation axis; and
e) determining size and/or shape of the optical defect by means of previously measured comparison values.

2. The method according to claim 1, further comprising measuring scattered light intensities at another scattering angle (θₛ₂) with respect to the rotation axis as a function of said rotation angle and determining a difference between said scattered light intensities at said scattering angle (θₛ₁) and said scattered light intensities at said another scattering angle (θₛ₂) and ascertaining a type of said optical defect from said difference.

3. The method according to claim 1, wherein the irradiating of the transparent material occurs with a light beam propagated along the rotation axis.

4. The method according to claim 1, wherein said light is white light, infrared light, light with a wavelength in a visible spectral range, ultraviolet light or light with a wavelength in a deep ultraviolet spectral range.

5. The method according to claim 1, wherein said light source is a laser.

6. An apparatus for evaluating optical defects in a transparent material, said apparatus comprising
a light source arranged to irradiate the transparent material with light from the light source so as to produce scattered light from an optical defect in the transparent material;
a holder for the transparent material, said holder being rotatable about a rotation axis;
a detector for detecting the scattered light, which is arranged so as to be oriented at any of a plurality of scattering angles (θₛ) with respect to a path of light rays from the light source;
a computer-assisted memory unit; and
a signal transmitter that transmits a spatial position of the detector and a rotation angle (φₛ) to the computer-assisted memory unit;
wherein the detector measures intensities of the scattered light as a function of the rotation angle and transmits the scattered light intensities to the computer-assisted memory unit and wherein the computer-assisted memory unit correlates or assigns the scattered light intensities to respective rotation angles.

7. The apparatus according to claim 6, wherein the light source generates a light beam that is propagated along the rotation axis of the holder.

8. The apparatus according to claim 6, wherein said detector comprises a CCD-camera and/or a photodiode array.

9. A method of manufacturing a lens, a prism, an optical window, an optical component for DUV lithography, a stepper, an excimer laser, a wafer or a computer chip, or an integrated circuit or electronic unit containing said computer chip, said method comprising the method according to claim 1.

10. A method of manufacturing a lens, a prism, an optical window, an optical component for DUV lithography, a stepper, an excimer laser, a wafer or a computer chip, or an integrated circuit or electronic unit containing said computer chip, said method comprising using the apparatus according to claim 6.
